(19) United States
(12) Patent Application Publication
(10) Pub. No.: US 2016/0377010 A1
(43) Pub. Date: Dec. 29, 2016

(54) METHOD FOR DIAGNOSING A FUNCTION OF AN INTERNAL COMBUSTION ENGINE

(71) Applicant: Robert Bosch GmbH, Stuttgart (DE)

(72) Inventors: Anja BLAU, Stuttgart (DE); Mathias Maehler, Ludwigsburg (DE); Roman Meyer, Stuttgart (DE)

(21) Appl. No.: 15/188,443

(22) Filed: Jun. 21, 2016

(30) Foreign Application Priority Data
Jun. 23, 2015 (DE) 102015211565.8

(51) Int. Cl. F02D 41/26; F02M 65/00

(52) U.S. Cl. CPC F02D 41/26; F02M 65/00

(57) ABSTRACT

A method for diagnosing a function of an internal combustion engine, which includes one injector of an intake-manifold injection, one injector of a direct injection and one cylinder. Fuel may be applied to the cylinder with the aid of the injector of the intake-manifold injection and/or with the aid of the injector of the direct injection. The method includes the steps of determining an operating state of the internal combustion engine, which is characterized by an injection and/or injections used for injecting fuel into the cylinder, selecting a diagnostic function for the cylinder as a function of the determined operating state and carrying out the selected diagnostic function for the cylinder.

### CROSS REFERENCE

The present application claims the benefit under 35 U.S.C. §119 of German Patent Application No. DE 102015211565.8 filed on Jun. 23, 2015, which is expressly incorporated herein by reference in its entirety.

### FIELD

The present invention relates to a method for diagnosing a function of an internal combustion engine, an electronic control unit for controlling a diagnosis of a function of an internal combustion engine, a computer program and a machine-readable storage medium.

### BACKGROUND INFORMATION

The California Air Resources Board (CARB) legislation from 2016 requires a diagnosis for the function of systems and components of an internal combustion engine influencing exhaust gas across different operating states of the internal combustion engine for vehicles in the United States. Such systems and components may be, for example, an injection system used as well as its injectors. Such a diagnosis is, for example, a so-called cylinder imbalance diagnosis, which examines the effects of cylinder-individual deviations of a fuel-air mixture on the uneven running of the internal combustion engine during the driving operation.

Conventional internal combustion engines may have a so-called dual system, in which an intake-manifold injection and a direct injection are coupled for cylinders of the internal combustion engine. Thereby, fuel may be applied to one cylinder of the internal combustion engine with the aid of one injector of the intake-manifold injection and/or with the aid of one injector of the direct injection. It is desirable to provide a diagnosis of a function of such an internal combustion engine having a dual system.

### SUMMARY

According to a first aspect of the present invention, a method for diagnosing a function of an internal combustion engine is provided, which includes one injector of an intake-manifold injection, one injector of a direct injection and one cylinder, it being possible to apply fuel to the cylinder with the aid of the injector of the intake-manifold injection and/or with the aid of the injector of the direct injection, including the steps of determining an operating state of the internal combustion engine, which is characterized by an injection or injections used for injecting fuel into the cylinder, selecting a diagnostic function for the cylinder as a function of the determined operating state and carrying out the selected diagnostic function for the cylinder.

According to the present invention, a method is thus provided, in which a cylinder-individual error diagnosis is provided for a function of an internal combustion engine, which is designed as a dual system including an intake-manifold injection and a direct injection and may be operated in a pure injection operation using exclusively the intake-manifold injection or the direct injection during a combustion stroke of the internal combustion engine or in a mixed injection operation, in which the intake-manifold injection and the direct injection are used in parallel. Here, the function may relate to the mode of operation of the injections and/or the operating state may be characterized by an exclusive use of the intake-manifold injection, by an exclusive use of the direct injection or by a parallel use of the intake-manifold injection and the direct injection for injecting fuel into the cylinder. The selection and carrying out of the diagnostic function as a function of the determined operating state may make a simple implementation of the method possible, since a separate diagnostic path for a cylinder may be provided per determined operating state.

In one specific embodiment, the method may further include setting a value of one or multiple operating parameters of the injector or the injectors used for the cylinder in the determined operating state, based on the result of the diagnostic function carried out. This measure advantageously makes an error correction possible during the operation of the intake-manifold injection or direct injection, since a direct feedback may be effectuated between the error diagnosis and the relevant components of the internal combustion engine. Operating parameters of the injector or the injectors may, for example, be a point in time of opening or closing, a pressure of the fuel to be injected or a stroke position of the injector.

In one specific embodiment, the diagnostic function may be selected and carried out in cylinder-individual fashion. As a result, differently used comparative values of the diagnostic function may be used, for example, for different cylinders, so that a particularly exact error detection for the cylinder is enabled.

The operating state may be determined in a cylinder-individual fashion, i.e., for the individual cylinder, so that a different injection type for different cylinders of an internal combustion engine may be provided.

In one specific embodiment, the operating state of the internal combustion engine may be determined repeatedly during a test cycle of the diagnosis, and one or multiple of the comparative values used for the diagnostic function may be adjusted according to a most recently determined operating state of the internal combustion engine if the operating state of the internal combustion engine changes. Based on this measure, the diagnostic function may continue to result in a correct result if the operating state is switched over, since the relevant comparative values, which are used by the diagnostic function, are adjusted according to the new operating state.

In one specific embodiment, the diagnostic function in a determined operating state, which is characterized by the parallel use of the intake-manifold injection and the direct injection, may take into account a ratio between an injection quantity of the fuel into the cylinder with the aid of the injector of the intake-manifold injection and an injection quantity of the fuel into the cylinder with the aid of the injector of the direct injection, which may typically be denoted as a split factor, for one or multiple comparative values of the diagnostic function. In other words, in the case of a mixed operation of the internal combustion engine, the comparative values implemented by the diagnostic function may be selected as a function of the split ratio. As a result, a granularity of the diagnosis is effectuated, which may take into account the fact that a change of the split factor, which may act on the internal combustion engine in a torque neutral manner, may nonetheless cause a change of the uneven running of the internal combustion engine.

The diagnostic function may detect an uneven running of the internal combustion engine as a function of a deviation of a fuel-air mixture injected into the cylinder, and the diagnosis may be, for example, a cylinder imbalance diagnosis. The comparative values may in this case relate to at least one of the following parameters: deviation of the fuel-air mixture from the expected fuel-air mixture at instantaneous driving behavior, speed of the internal combustion engine, load range of the internal combustion engine, etc.

In one specific embodiment, the determined operating state may be characterized by the parallel use of the intake-manifold injection and the direct injection, and the method may further include selection and carrying out of an additional diagnostic function for the cylinder for at least one of the operating states, which may be characterized by an exclusive use of the intake-manifold injection and by an exclusive use of the direct injection. For example, an error state may be detected during a mixed operation and carried out again after a pass of the diagnostic function in at least one of the two pure operations, so that a maloperation may be indicated in one of the two injections consistent with the detected error. In this case, individual error characteristics may be defined for the mixed operation, which may differ from error characteristics of the injection systems during pure operation. The diagnostic function in a pure operation may be carried out immediately following the diagnostic function in mixed operation or at staggered intervals in relation to it. In this connection, a suitable switchover between the operating states may be controlled. An appropriate coordinator is created in particular for this purpose. The suitable switchover between the operating states is variable, so that different designs of the coordinator are possible.

Following the diagnosis carried out for the mixed operation and optionally for one or both pure operations, the values of the operating parameters of the particular injectors may be reset based on all diagnostic results.

According to a second aspect of the present invention, an electronic control unit for controlling a diagnosis of a function of an internal combustion engine is provided, which includes one injector of an intake-manifold injection, one injector of a direct injection and one cylinder, it being possible to apply fuel to the cylinder with the aid of the injector of the intake-manifold injection and/or with the aid of the injector of the direct injection, the control unit being designed for determining an operating state of the internal combustion engine, which is characterized by an injection or injections used for injecting fuel into the cylinder, selecting a diagnostic function for the cylinder as a function of the determined operating state and carrying out the selected diagnostic function for the cylinder.

The control unit may be designed for carrying out the steps of the method according to the first aspect. For this purpose, the control unit may have for each cylinder of the internal combustion engine, a diagnostic path for each of the operating states of the internal combustion engine to be determined. In each of the diagnostic paths, an array may be provided, which compares a measured value with a comparative value of the diagnostic function, in order to carry out accordingly a correction of values of operating parameters for the injector or injectors of the relevant cylinder.

According to a third aspect of the present invention, a computer program is provided, which is designed for carrying out steps of a method according to the first aspect.

According to a fourth aspect of the present invention, a machine-readable storage medium is provided, on which a computer program according to the fourth aspect is stored.

### BRIEF DESCRIPTION OF THE DRAWINGS

Specific embodiments are explained in greater detail in the following with reference to the figures.

FIG. 1 shows a schematic view of an engine system, the function of which may be diagnosed with the aid of a method according to one specific embodiment of the present invention.

FIG. 2 shows a schematic view of a control unit of the engine system in FIG. 1.

FIG. 3 schematically shows a method according to one specific embodiment of the present invention.

### DETAILED DESCRIPTION OF EXAMPLE EMBODIMENTS

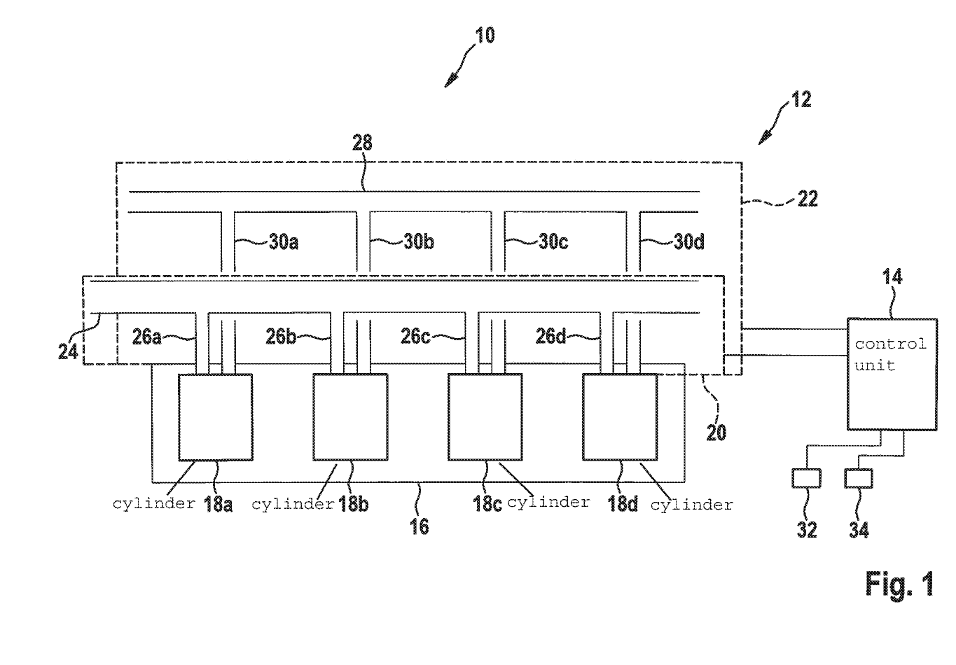

An engine system 10 shown in FIG. 1 includes an internal combustion engine 12 and a control unit 14, which are electronically coupled. Internal combustion engine 12 includes an engine bank 16 including four cylinders 18a through 18d, an intake-manifold injection 20 and a direct injection 22. Intake-manifold injection 20 has an intake-manifold 24, which is fluidically connected to injectors 26a through 26d of intake-manifold injection 20. Each injector 26a through 26d is in each case fluidically connected to one other of cylinders 18a through 18d. Direct injection 22 includes a high-pressure accumulator 28, which is fluidically connected to injectors 30a through 30d of direct injection 22. Each of injectors 30a through 30d is fluidically connected to one other of cylinders 18a through 18d. Control unit 14 is electronically coupled to intake-manifold injection 20 and direct injection 22, so that control unit 14 is designed for activating injectors 26a through 26d, 30a through 30d.

An uneven running of internal combustion engine 12 is calculated based on a signal of a sensor 32, which is attached to a crankshaft of internal combustion engine 12. Another sensor 34 measures a deviation of a fuel-air mixture of internal combustion engine 12. Sensor 34 is situated, for example, in an exhaust gas system of engine system 10.

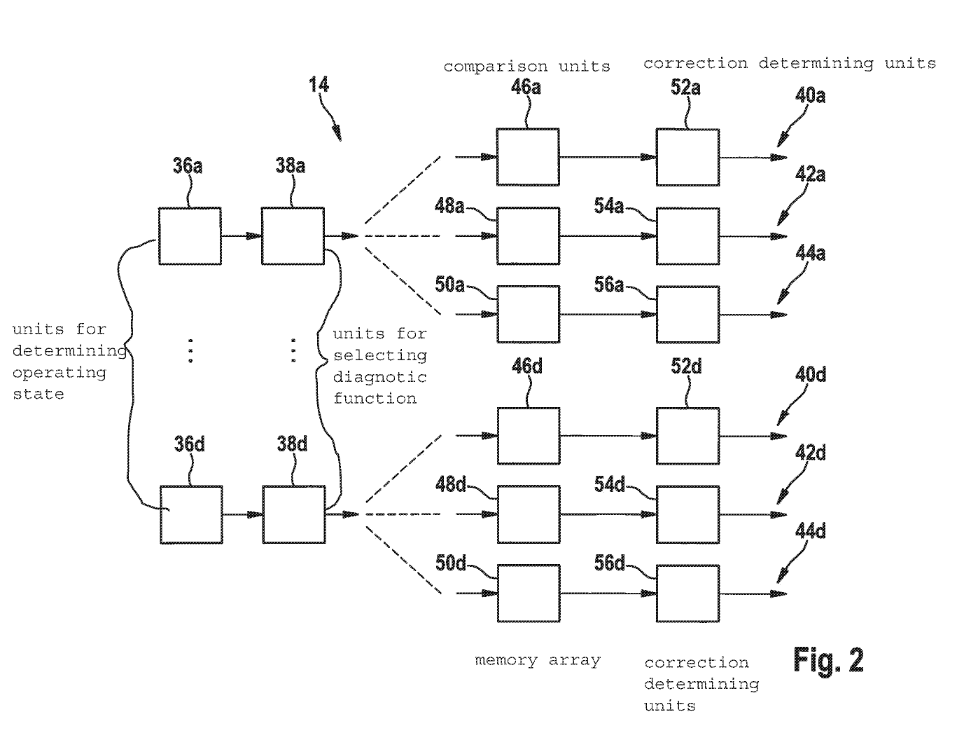

As shown in FIG. 2, for each of cylinders 18a through 18d, control unit 14 has a unit 36 for determining an operating state, which is characterized by a used injection 20, 22 or injections 20, 22, a unit 38 for selecting a diagnostic function as a function of the determined operating state and three diagnostic paths 40 through 44. For the sake of clarity, only units 36a, 36d, 38a, 38d, and diagnostic paths 40a through 44a, 40d through 44d for cylinders 18a, 18d are shown in FIG. 2. In each of diagnostic paths 40a through 44a, 40d through 44d, a comparison unit 46a through 50a, 46d through 50d designed as a memory array is provided, to which is applied an uneven running calculated from the measuring result of sensor 32 and/or a measuring result of sensor 34 and/or an input value which was ascertained based on the two measuring results, and a different diagnostic function is implemented as a function of diagnostic path 40a through 44a, 40d, 44d. Comparative values of the particular diagnostic function, which are stored in comparison unit 46 through 50 or are supplied to it, make a comparison of the measured value or values with the comparative values possible, so that, for example, if the comparison values are exceeded, an appropriate piece of information may be output to a correction determining unit 52a through 56a, 52d through 56d of control unit 14. Output values of correction determining unit 52a through 56a, 52d through 56d are used for setting values of operating parameters of intake-manifold injection 20 or direct injection 22 of internal combustion engine 12 for respective cylinders 18a through 18d.

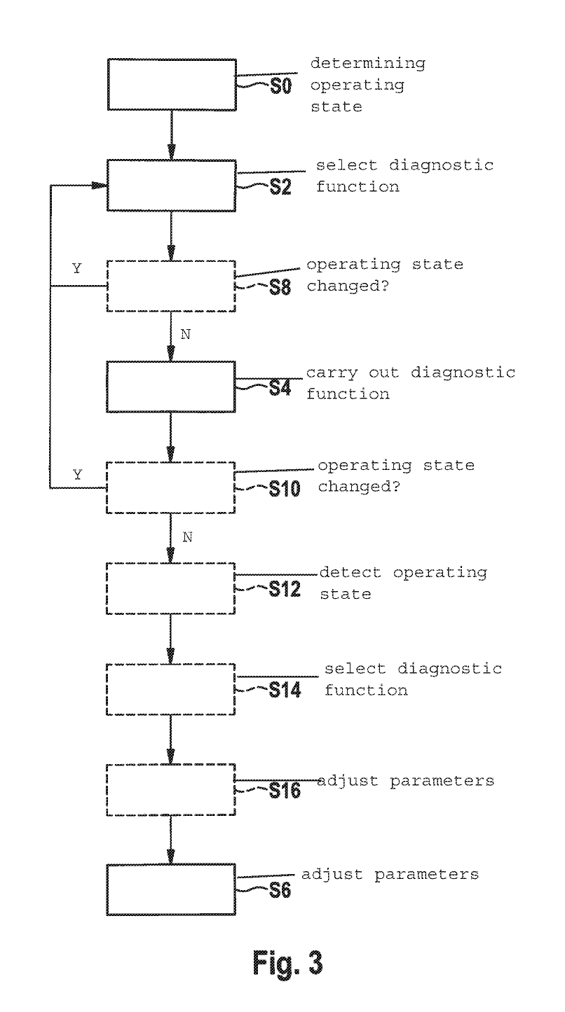

As shown in FIG. 3, in an operation of internal combustion engine 12 with the aid of control unit 14, an operating state of cylinder 18a through 18d is determined in a method step S0 with the aid of unit 36a through 36d. In a subsequent method step S2, a diagnostic function for cylinder 18a through 18d and accordingly one of diagnostic paths 40a through 44a is selected according to the determined operating state with the aid of unit 38a through 38d. In a further method step S4, the diagnostic function for cylinder 18a through 18d may be carried out with the aid of comparison units 46a through 50a, 46d through 50d, so that in a subsequent method step S6, values of operating parameters of injector or injectors 26a through 26d, 30a through 30d of intake-manifold injection 20 or direct injection 22 may be adjusted based on the result of the diagnosis with the aid of correction determining units 52a through 56a, 52d through 56d. It is understood that the method may be carried out simultaneously for multiple or all cylinders 18a through 18d.

In optional method steps S8, S10, which may be carried out between method steps S2 and S4 or S4 and S6, the operating state of cylinder 18a through 18d is determined again with the aid of unit 36a, 36d. If the operating state is unchanged in relation to the operating state detected in method step S0, the diagnostic function is carried out unchanged in each of diagnostic paths 40a through 44a, 40d through 44d. In particular, the comparison values of the particular diagnostic function used by comparison unit 46a through 50a, 46d through 50d continue to be used. If it is, however, detected that the operating state has changed, method step S2 is carried out again, so that a new diagnostic function for cylinder 18a through 18d is selected. This corresponds to an adjustment of the used comparative values of comparison unit 46a through 50a, 46d through 50d of diagnostic paths 40a through 44a, 40d through 44d to the changed operating state.

In the case that the operating state detected in step S0 is consistent with a mixed operation of internal combustion engine 12, it is possible, subsequent to step S4 or S10 (if present), to detect the operating state of cylinder 18a through 18d in step S12 for each of cylinders 18a through 18d after a switchover into another operating state. This operating state is consistent with a pure operation of internal combustion engine 12, in which either intake-manifold injection 20 or direct injection 22 is used for cylinder 18a through 18d. Subsequently, a method step S14 may be carried out, in that a diagnostic function is selected as a function of the determined operating state with the aid of unit 36a, 36d. Subsequently, in a step S16, the selected diagnostic function is carried out with the aid of comparison units 42a through 46a, 42d through 46d, so that in step S16, values of operating parameters of intake-manifold injection 20 or direct injection 22 are set for cylinder 18a through 18d based on the diagnostic function carried out with the aid of correction determining unit 52a through 56a, 52d through 56d in steps S4 and S16.

What is claimed is:

1. A method for diagnosing a function of an internal combustion engine, which includes one injector of an intake-manifold injection, one injector of a direct injection and one cylinder, fuel being able to be applied to the cylinder one of: i) with the aid of the injector of the intake-manifold injection, and ii) with the aid of the injector of the direct injection, the method comprising:
determining an operating state of the internal combustion engine, which is characterized by at least one injection used for injecting fuel into the cylinder;
selecting a diagnostic function for the cylinder depending on the determined operating state; and
carrying out the selected diagnostic function for the cylinder.

2. The method as recited in claim 1, further comprising:
setting a value of at least one parameter of the injector or the injectors used for the cylinder in the determined operating state, based on the result of the diagnostic function carried out.

3. The method as recited in claim 1, wherein the diagnostic function is selected and carried out in cylinder-individual fashion.

4. The method as recited in claim 1, wherein the operating state of the internal combustion engine is determined repeatedly during a test cycle of the diagnosis, at least one comparative value used by the diagnostic function being adjusted according to a most recently determined operating state of the internal combustion engine if the operating state of the internal combustion engine changes.

5. The method as recited in claim 1, wherein the diagnostic function in the determined operating state, which is characterized by a parallel use of the intake-manifold injection and the direct injection, takes into account a ratio between an injection quantity of the fuel into the cylinder with the aid of the injector of the intake-manifold injection and an injection quantity of the fuel into the cylinder with the aid of the injector of the direct injection for at least one comparative value.

6. The method as recited in claim 1, wherein the determined operating state is characterized by a parallel use of the intake-manifold injection and the direct injection, and the method further comprising:
selecting and carrying out an additional diagnostic function for the cylinder for at least one of the operating states, which are characterized by an exclusive use of the intake-manifold injection and by an exclusive use of the direct injection.

7. An electronic control unit for controlling a diagnosis of a function of an internal combustion engine, which includes one injector of an intake-manifold injection, one injector of a direct injection and one cylinder, fuel being able to be applied to the cylinder at least one of: i) with the aid of the injector of the intake-manifold injection, and ii) with the aid of the injector of the direct injection, the control unit being configured to:
determine an operating state of the internal combustion engine, which is characterized by at least one injection used for injecting fuel into the cylinder;
select a diagnostic function for the cylinder depending on the determined operating state; and
carry out the selected diagnostic function for the cylinder.

8. A non-transitory machine-readable storage medium on which is stored a computer program for diagnosing a function of an internal combustion engine, which includes one injector of an intake-manifold injection, one injector of a direct injection and one cylinder, fuel being able to be applied to the cylinder one of: i) with the aid of the injector of the intake-manifold injection, and ii) with the aid of the injector of the direct injection, the computer program, when executed by a processor, causing the processor to perform:
determining an operating state of the internal combustion engine, which is characterized by at least one injection used for injecting fuel into the cylinder;
selecting a diagnostic function for the cylinder depending on the determined operating state; and
carrying out the selected diagnostic function for the cylinder.
